(19) United States
(12) Patent Application Publication
(10) Pub. No.: US 2020/0216737 A1
(43) Pub. Date: Jul. 9, 2020

(54) SHAPE STABLE THERMAL ENERGY STORAGE SYSTEMS AND METHODS FOR MAKING AND USING THEM

(71) Applicant: ENTROPY SOLUTIONS INC., Plymouth, MN (US)

(72) Inventors: Steven Keith MCNEIL, Northport, AL (US); William Rusty SUTTERLIN, Hoover, AL (US); Aymara M. ALBURY, Tuscaloosa, AL (US)

(21) Appl. No.: 16/630,357

(22) PCT Filed: Jul. 10, 2018
(86) PCT No.: PCT/US2018/041431

§ 371 Date: Jan. 10, 2020

Related U.S. Application Data
(60) Provisional application No. 62/530,816, filed on Jul. 10, 2017.

(51) Int. Cl. C09K 5/06

(52) U.S. Cl. CPC C09K 5/063

(57) ABSTRACT

In alternative embodiments, provided are shape stable Phase Change Material (PCMs), which in alternative embodiments, are encapsulated shape stable PCMs. In alternative embodiments, provided are shape stable Phase Change Materials (PCMs) comprising a mixture of: a hydrogenated diene copolymer, an (ethylene-octene) multi-block copolymer, a triblock copolymer, a diblock copolymer, an olefin or a polyolefin block copolymer; a PCM comprising at least one fatty acid or fatty acid derivative; a paraffin; a polyol; a fatty alcohol; and a eutectic or a eutectic mixture. In alternative embodiments, provided are methods for manufacturing the PCMs as provide herein. In alternative embodiments, these PCMs are used in Thermal Energy Storage (TES) systems for thermal management in different applications such as electronics, clothing, building or a building material, automotive, aircraft, medical, food and drug storage, and industrial applications.

### RELATED APPLICATIONS

This Patent Convention Treaty (PCT) International Application claims the benefit of priority to U.S. Provisional Application No. 62/530,816, filed Jul. 10, 2017. The aforementioned application is expressly incorporated herein by reference in its entirety and for all purposes.

### FIELD OF THE INVENTION

This invention generally relates to thermoregulation, thermal protection and insulation, Phase Change Material (PCMs) and nucleating agents. In alternative embodiments, provided are shape stable Phase Change Material (PCMs), which in alternative embodiments, are encapsulated shape stable PCMs. In alternative embodiments, provided are shape stable Phase Change Materials (PCMs) comprising a mixture of: a hydrogenated diene copolymer, an (ethylene-octene) multi-block copolymer, a triblock copolymer, a diblock copolymer, an olefin or a polyolefin block copolymer; a PCM comprising at least one fatty acid or fatty acid derivative; a paraffin; a polyol; a fatty alcohol; and a eutectic or a eutectic mixture. In alternative embodiments, provided are methods for manufacturing the PCMs as provide herein. In alternative embodiments, these PCMs are used in Thermal Energy Storage (TES) systems for thermal management in different applications such as electronics, clothing or any wearable product, building or a building material, automotive, aircraft, medical, food and drug storage, and industrial applications.

### BACKGROUND

There is a general desire in all industries to be energy efficient. There is also a general desire to reduce the use of fossil fuel resources due to concerns over climate change and energy security. Buildings, for example, require significant amounts of energy for heating and cooling and there is a need to reduce the costs associated with thermal management. Energy capture and storage from building and the controlled release of stored energy back into the building is increasingly viewed as a critical component to reducing overall energy demand in commercial and industrial applications. The thermal management of temperature sensitive payloads during transport can also require significant amounts of energy. In the automotive industry, there is a desire to increase efficiency and reduce the fuel usage associated with maintaining a comfortable temperature in the cabin of vehicles.

One approach of decreasing the amount of energy needed for thermal management is the use of phase change materials. A “phase change material” (PCM) is a material that stores or releases a large amount of energy during a change in state, or “phase”, e.g. crystallization (solidifying) or melting (liquefying) at a specific temperature. The amount of energy stored or released by a material during crystallization or melting, respectively, is the latent heat of that material. During such phase changes, the temperature of the material remains relatively constant.

Typically, all PCMs are contained in some type of container consisting of a plastic, metal, or film containment. An issue with all PCMs is that when the PCM melts forming a low viscosity liquid with a low surface tension, and if the containment has any defect, such as a hole, crack, or improper seal, the PCM will escape the containment. Additionally, it is known that organic PCMs, such a octadecane, have compatibility issues with many common plastics containments, such as polyethylene. Over time, the organic PCM will absorb/permeate into the walls of the polyethylene container, softening the plastic, and will eventually seep through the polyethylene wall escaping to the outside environment. To prevent the PCM from escaping a containment with a defect and to help improve the compatibility between with PCM and containment, there is a desire to gel PCMs.

Many different gelling agents can increase a PCM's viscosity or produce a shape form stable oil gel. Viscosity modifiers, such as ethyl cellulose, can significantly increase an oil's viscosity forming an oil gel at low ethyl cellulose concentrations, but does not form a shape form stable gel, as in US 2016/0081374 A1.

Also, hydrogenated block copolymers, such as styrene-ethylene-butylene-styrene (SEBS) tri-block copolymers, styrene-ethylene-propylene-styrene (SEPS) tri-block copolymer, and other thermoplastic elastomers, can produce a shape form stable PCM gels consisting of a paraffin and hydrogenated block copolymer, as in U.S. Pat. No. 9,556,373 B2, or 9,598,622. The hydrogenated block copolymers are desirable polymeric gelling agents, since these gelling agents can form shape stable PCM gels at low polymer concentrations, such as less than twenty percent, consist of high PCM loadings, and the oil gel remains dimensionally stable when the PCM is in the melted liquid state. While these hydrogenated block copolymers can form shape stable oil gels with paraffins, the same cannot be said about other PCMs, such as fatty acid derivatives or fatty alcohols. These shape stable gels also have the disadvantage that as the PCM undergoes phase transitions from the melted state to the crystalline state, the PCM will slowly leach from the shape stabilizing polymer. Another form of containment is needed to contain the PCM that leaches from PCM shape stable gel.

Commercially, these shape-stabilized gels have only been produced in square dimensions by a molding process which is ideal for cold chain logistics due to the increase surface area coverage, but limits their use for other potential applications which require smaller dimensions. While the molding process is capable of producing the dimensionally stable PCM gels, there are drawbacks which must be considered such as the curing/cooling time required before the gel can be removed from the mold, the PCM gels adhering to the molds, and slower production rates.

### SUMMARY

In alternative embodiments, provided are shape stable Phase Change Materials (PCMs) comprising:

(1) (a) (i) a hydrogenated diene copolymer, or equivalents,
wherein optionally the hydrogenated diene copolymer comprises a conjugated diene copolymer, or a compound as described in U.S. Pat. No. 8,618,205;
(ii) an (ethylene-octene)-multi-block copolymer, an (ethylene-butylene)-multi-block copolymer, an (ethylene-octene)-crystalline block copolymer or an (ethylene-butylene)-crystalline block copolymer, or equivalents,
wherein optionally the (ethylene-octene)-multi-block copolymer comprises a compound as described in U.S. Pat. No. 9,593,237;
(iii) a triblock copolymer comprising a styrene-ethylene-butylene-styrene (SEBS), a styrene-ethylene-propylene-styrene (SEPS), a styrene-ethylene-ethylene-propylene-styrene (SEEPS), or a combination or equivalents thereof,
wherein optionally the triblock copolymer comprises a compound as described in U.S. Pat. No. 9,556,373, or 9,598,622;
(iv) a diblock copolymer comprising a styrene-ethylene-propylene (SEP), a styrene-ethylene-butylene (SEB), a styrene-ethylene-ethylene (SEE), or a combination or equivalents thereof,
wherein optionally the diblock copolymer comprises a compound as described in U.S. Pat. No. 9,556,373, or 9,598,622;
(v) an olefin or polyolefin block copolymer, or equivalent; or
(vi) any combination of (i) to (v) or all of (i) to (v);

(b) a PCM comprising at least one fatty acid or fatty acid derivative;

(c) a paraffin, or equivalent;

(d) a polyol, or equivalent,

wherein optionally the polyol comprises: an aliphatic linear dialkyl ether with a melting point below 100° C. as determined by differential scanning calorimetry, or a polyether,

wherein optionally the polyol is an ether, or a linear ether, having a chain length of between about C6 to C10, C12 to C18, or C6 to C36 in length, or any combination thereof, and optionally the linear ether comprises a di-n-hexyl ether, a di-n-octyl ether, a di-n-decyl ether, a di-n-lauryl ether, a di-n-myristyl ether, a di-n-cetyl ether, a di-n-stearyl ether or any combinations or equivalents thereof;

(e) a fatty alcohol or equivalent; and

(f) a eutectic or equivalent or a eutectic mixture; or

(2) the shape stable PCM of (1), further comprising a coat or coating, or an outer layer encapsulating the shape stable PCM, or a pelletized form or the shape stable PCM,

wherein optionally the encapsulating comprises a process comprising prilling, an extruder pelletization technique (optionally as described in US patent application publication no. 2017/0087799 A1), a pastillation technique, an injection molding technique, a cryogenic pelletization technique, a spheronization technique, a granulation technique, a spray congealing technique, or an equivalent;

and optionally the coating or encapsulation of the PCM-comprising particles, or coating of the encapsulated or pelletized particles, comprises coating or encapsulating material comprising a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof,

wherein optionally the thickness of the coating is about 0.1 μm to about 1000 μm, or about 1.0 μm to about 100 μm,

and optionally the coating level is from about 1% percentage by weight (w.t.) to about 99% percentage by weight (w.t.), from between about 20% percentage by weight (w.t.) to about 80% percentage by weight (w.t.), or from between about 30% percentage by weight (w.t.) to about 70% percentage by weight (w.t.), and optionally the coating comprises a process comprising a Wurster coating technique, a tablet coating technique, a pan coating technique, a powder layering coating technique, a dip coating technique, a spray drying technique, and equivalents.

In alternative embodiments, the pelletization process produces PCM particles about 1 to 6 mm, 2 to 5 mm, or about 3 to 4 mm, in width; and about 1 to 2 mm, or about 0.5 to 3 mm in height. In alternative embodiments, provided are PCM particles (whether or not pelletized, or whether or not encapsulated) having dimensions of between about: 0.5 to 6, 7, 8, 9, 10, 11, 12, 13, 14, or 15 or more mm; about 1 to 6 mm; about 2 to 5 mm, or about 3 to 4 mm in width, or in a first dimension; and having dimensions of between about 0.5 to 6, 7, 8, 9, 10, 11, 12, 13, 14, or 15 or more mm; about 3 to 4 mm, about 1 to 2 mm, or about 0.5 to 3 mm, in height (or in a second dimension). In alternative embodiments, provided are PCM particles (whether or not pelletized, or whether or not encapsulated) having a round or an ovoid-like, oval, round or an elliptical shaped dimension having a diameter of, or an average diameter of, between about: 0.25 to 25 mm, 1 to 20 mm, 2 to 15 mm, 5 to 10 mm, or 0.5, 1, 2, 3, 4, 5, 6, 7, 8, 9, or 10 or more mm.

In alternative embodiments, PCM particles (whether or not pelletized, or whether or not encapsulated) have a shape having dimensions of 10 mm×100 mm, 15 mm×90 mm, 20 mm×80 mm, 25 mm×50 mm, 25 mm×75 mm, 30 mm×50 mm, or are shaped substantially ovoid, elliptical or round having a diameter of, or an average diameter of, between about 5 and 100 mm, between about 20 and 80 mm or between about 25 and 75 mm.

In alternative embodiments, the shape stable Phase Change Materials (PCMs) as provided herein consist essentially of, or consist of:

(a) (i) a hydrogenated diene copolymer or equivalents;
(ii) an (ethylene-octene) multi-block copolymer, or equivalents;
(iii) a triblock copolymer selected from the group consisting of styrene-ethylene-butylene-styrene (SEBS), styrene-ethylene-propylene-styrene (SEPS), styrene-ethylene-ethylene-propylene-styrene (SEEPS), and combinations thereof;
(iv) a diblock copolymer selected from the group consisting of styrene-ethylene-propylene (SEP), styrene-ethylene-butylene (SEB), styrene-ethylene-ethylene (SEE), and combinations thereof, and equivalents thereof;
(v) an olefin or polyolefin block copolymer, or equivalent; or
(vi) any combination of (i) to (v) or all of (i) to (v);

(2) a PCM comprising at least one fatty acid or fatty acid derivative;

(3) a paraffin, or equivalent;

(4) a polyol, or equivalent;

(5) a fatty alcohol or equivalent; and

(6) a eutectic or equivalent or a eutectic mixture; or

(b) the ingredients of PCMs as provided herein.

In alternative embodiments, the at least one fatty acid or fatty acid derivative comprises:

(a) a short-chain fatty acid (SCFA), or a fatty acids with an aliphatic tail of fewer than six carbons, or a butyric acid; or a medium-chain fatty acids (MCFA), or a fatty acid with an aliphatic tails of about 6 to 12 carbons; a long-chain fatty acid (LCFA), or a fatty acid with an aliphatic tail of between 13 to 21 carbons, or between about 10 to 24 carbons; or, a very long chain fatty acid (VLCFA), or a fatty acids with an aliphatic tails longer than 22 carbons, or between about 22 and 30 carbons; or any combination thereof,

and optionally the fatty acid comprises a C2 to C40, or C3 to C30, alkyl or alkene chain, or comprises a substituted C2 to C40, or C3 to C30, alkyl or alkene chain,

and optionally the fatty acid is a saturated or an unsaturated fatty acid,

and optionally the fatty acid is: a myristoleic acid or 9-tetradecenoic acid; a palmitoleic acid or 9-hexadecenoic acid; a sapienic acid, an oleic acid; an elaidic acid; a vaccenic acid; a linoleic acid; a linoelaidic acid; an arachidonic acid, or any combination thereof; or

(b) a fatty acid or fatty acid derivative compound as described in U.S. Pat. No. 6,574,971 B2, or U.S. Pat. App. Pub. No. 2002/0011587 A1.

(d) any combination of compounds as described in (a) and/or (b).

In alternative embodiments, the polyol comprises a monomeric polyol, optionally a sugar alcohol, optionally a glycerin, a polyethylene glycol (PEG), a pentaerythritol, an ethylene glycol or a sucrose, or a polymeric polyol, optionally a polyether or a polyester.

In alternative embodiments, the fatty alcohol comprises a straight chain primary alcohol, a primary alcohol 4 to 26 carbons long, a fatty alcohol derived from a natural fat or an oil, or derived from an animal fat (optionally a tallow) or vegetable fat, an oleyl alcohol, or any combination thereof.

In alternative embodiments, the eutectic mixture comprises:

(a) any mixture of elements as provided herein,

(b) a fatty acid derivative combined with a second fatty acid derivative, a paraffin, a polyol, a linear ether, a fatty alcohol, a fatty acid, or any combination thereof;

a fatty acid combined with a fatty acid derivative, a paraffin, a polyol, a linear ether, a fatty alcohol, a fatty acid, or any combination thereof;

a paraffin combined with a fatty acid derivative, a paraffin, a polyol, a linear ether, a fatty alcohol, a fatty acid, or any combination thereof;

a polyol combined with a fatty acid derivative, a paraffin, a polyol, a linear ether, a fatty alcohol, a fatty acid, or any combination thereof; or

a fatty alcohol combined with a fatty acid derivative, a paraffin, a polyol, a linear ether, a fatty alcohol, fatty acid, or any combination thereof; or

(c) any combination of eutectic mixtures of (a) and/or (b).

In alternative embodiments, the amount of:

the hydrogenated diene copolymer or the (ethylene-butylene)-crystalline block copolymer, or equivalents, or the (ethylene-octene)-crystalline block copolymer or equivalents,

the ethylene/octene multi-block copolymer, or equivalents,

the triblock or diblock copolymers, or equivalents, and/or

the olefin or polyolefin block copolymers, or equivalents,

in the shape stable PCM comprises:

from about 5% percentage by weight (w.t.) to about 95% percentage by weight (w.t.), from between about 7.5% percentage by weight (w.t.) to about 50% percentage by weight (w.t.), or from between about 10% percentage by weight (w.t.) to about 20% percentage by weight (w.t.).

In alternative embodiments, the amount of the PCM comprising at least one fatty acid or fatty acid derivative in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the amount of linear ether in the PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the amount of paraffin in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the amount of the polyol comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the amount of fatty alcohol in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the amount of eutectic in the shape stable PCM comprises from 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

In alternative embodiments, the shape stable PCM comprises:

(a) about 15% (w.t.) hydrogenated diene copolymer and about 85% of a fatty acid derivative, a paraffin, a polyol, a linear ether, a fatty alcohol, or an eutectic;

(b) about 20% (w.t.) ethylene/octene multi-block copolymer and about 80% (w.t.) of a fatty acid, a fatty acid derivative, a paraffin, a polyol, a linear ether, a fatty alcohol, or an eutectic;

(c) about 10% (w.t.) triblock co-copolymer selected from the group consisting of styrene-ethylene-butylene-styrene (SEBS), styrene-ethylene-propylene-styrene (SEPS), styrene-ethylene-ethylene-propylene-styrene (SEEPS), and about 90% (w.t) of a fatty acid, fatty acid derivative, a paraffin, a polyol, a linear ether, a fatty alcohol, or an eutectic; or

(d) about 10% (w.t.) diblock copolymer selected from the group consisting of styrene-ethylene-propylene (SEP), styrene-ethylene-butylene (SEB), styrene-ethylene-ethylene (SEE), and about 90% (w.t) of a fatty acid, a fatty acid derivative, a paraffin, a polyol, a linear ether, a fatty alcohol, or a eutectic.

In alternative embodiments, provided are shape stable Phase Change Materials (PCMs) made by a process comprising (or, provided are methods of making shape stable PCMs comprising):

mixing the following components or ingredients to generate a mixture, the PCMs comprising this mixture:

(a) (i) a hydrogenated diene copolymer, or equivalents,
wherein optionally the hydrogenated diene copolymer comprises a conjugated diene copolymer, or a compound as described in U.S. Pat. No. 8,618,205;
(ii) an (ethylene-octene)-multi-block copolymer, an (ethylene-butylene)-multi-block copolymer, an (ethylene-octene)-crystalline block copolymer or an (ethylene-butylene)-crystalline block copolymer, or equivalents,
wherein optionally the (ethylene-octene)-multi-block copolymer comprises a compound as described in U.S. Pat. No. 9,593,237;
(iii) a triblock copolymer comprising a styrene-ethylene-butylene-styrene (SEBS), a styrene-ethylene-propylene-styrene (SEPS), a styrene-ethylene-ethylene-propylene-styrene (SEEPS), or a combination or equivalents thereof,
wherein optionally the triblock copolymer comprises a compound as described in U.S. Pat. No. 9,556,373, or 9,598,622;
(iv) a diblock copolymer comprising a styrene-ethylene-propylene (SEP), a styrene-ethylene-butylene (SEB), a styrene-ethylene-ethylene (SEE), or a combination or equivalents thereof,
wherein optionally the diblock copolymer comprises a compound as described in U.S. Pat. No. 9,556,373, or 9,598,622;
(v) an olefin or polyolefin block copolymer, or equivalent; or
(vi) any combination of (i) to (v) or all of (i) to (v);

(b) a PCM comprising at least one fatty acid or fatty acid derivative;

(c) a paraffin, or equivalent;

(d) a polyol, or equivalent,
wherein optionally the polyol comprises: an aliphatic linear dialkyl ether with a melting point below 100° C. as determined by differential scanning calorimetry, or a polyether,
wherein optionally the polyol is an ether, or a linear ether, having a chain length of between about C6 to C10, C12 to C18, or C6 to C36 in length, or any combination thereof, and optionally the linear ether comprises a di-n-hexyl ether, a di-n-octyl ether, a di-n-decyl ether, a di-n-lauryl ether, a di-n-myristyl ether, a di-n-cetyl ether, a di-n-stearyl ether or any combinations or equivalents thereof;

(e) a fatty alcohol or equivalent; and

(f) a eutectic or equivalent or a eutectic mixture;

and optionally pelletizing the PCM particle (the PCM particle is produced in pelletized form),

wherein optionally the pelletizing comprises a process comprising prilling, an extruder pelletization technique (optionally as described in US patent application publication no. 2017/0087799 A1), a pastillation technique, an injection molding technique, a cryogenic pelletization technique, a spheronization technique, a granulation technique, a spray congealing technique, or an equivalent,

and optionally the PCM particle has a size determined by molding or cutting or otherwise sizing to a desired dimension, or

(b) coating or encapsulating the shape stable PCM particle of (2)(a).

In alternative embodiments, the coating of the PCM-comprising particles, or coating of the encapsulated or pelletized particles, comprises use of a coating comprising a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof,

wherein optionally the thickness of the coating is about 0.1 to 100 μm,

and optionally the coating level is from about 0.5% to 1% percentage by weight (w.t.) to about 90% to 99% percentage by weight (w.t.), or from between about 5% to 20% percentage by weight (w.t.) to about 60% to 80% percentage by weight (w.t.), or from between about 20% to 30% percentage by weight (w.t.) to about 50% to 70% percentage by weight (w.t.), or about 0.25%, 5%, 1%, 2%, 3%, 4%, 5%, 6%, 7%, 8%, 9% or 10% or more by weight.

and optionally the coating comprises a process comprising a Wurster coating technique, a tablet coating technique, a pan coating technique, a powder layering coating technique, a dip coating technique, a spray drying technique, and equivalents.

In alternative embodiments, provided are products of manufacture comprising a shape stable Phase Change Material (PCM) as provided herein.

In alternative embodiments, the shape stable Phase Change Materials (PCMs) or products of manufacture as provided herein further comprise:

(a) an organic or an inorganic nucleating agent,

wherein optionally the organic nucleating agent comprises a polyolefin or polyalkene, wherein optionally the polyolefin comprises a poly-alpha-olefin,

and optionally the inorganic or organic nucleating agent is in a quantity of between about 0.01% to 1% by mass, or between about 0.1% to 0.5% by mass, or between about 0.01% to 0.1% by mass, or between about 0.5% to 1% by mass; and/or

(b) a filler comprised of an adsorbent material or a thermal conductivity improver,

wherein optionally the filler material is selected from the group consisting of: plastic, activated carbon, graphite, expanded graphite, fullers earth, perlite, diatomaceous earth, cellulose, fibers, silica, celite, wood pulp, corn stover, biomass, bentonite, vermiculite, gypsum, silicon dioxide, attapulgite, graphene oxide, aluminum oxide, cement, molecular sieves, zeolites, metal foams, kaolinite, chlorite, montomorillonite, muscovite, illite, cookeite, GRIT-O-COBB™, silicates, fumed silica, cenospheres, expanded clay aggregates, mica clays, smectite clays, polyacrylate and a combination thereof,

and optionally wherein the plastic is selected from the group consisting of: high-density polyethylene (HDPE) or polyethylene high-density (PEHD), Low-density polyethylene (LDPE), Poly(methyl methacrylate) (PMMA) or acrylic glass or acrylic (e.g., PLEXIGLAS™, ACRYLITE™, LUCITE™, PERSPEX™) polystyrene, Ethylene-vinyl acetate (EVA) or poly(ethylene-vinyl acetate) (PEVA), poly(ethylene terephthalate) (PET), thermoplastic elastomers (TPEs) such as styrenic block copolymers (TPE-s), ethylene/butylene block copolymers, crystalline ethylene/butylene block copolymers, thermoplastic olefins (TPE-o), elastomeric alloys (TPE-v or TPV), thermoplastic polyurethanes (TPU), thermoplastic copolyester, thermoplastic polyamides, acrylonitrile butadiene styrene (ABS), polypropylene (PP) or polypropene, equivalents thereof and combinations thereof.

In alternative embodiments, provided are thermal energy storage (TES) systems comprising a composition or product of manufacture as provided herein,

wherein optionally the TES or product of manufacture comprises pelletized PCM, non-pelletized PCM or a combination of pelletized and non-pelletized PCM,

wherein optionally the about half of the PCM in the TES or product of manufacture is pelletized and about half of the PCM in the TES or product of manufacture is non-pelletized, or between about 10% to about 90% of the PCM in the TES or product of manufacture is pelletized and between about 10% to about 90% of the PCM is non-pelletized,

and optionally the size of the pelletized PCM is between about 1 to 6 mm, 2 to 5 mm, or about 3 to 4 mm, in width; and between about 1 to 2 mm, or about 0.5 to 3 mm in height,

and optionally the non-pelletized PCM particles have a shape having dimensions of 10 mm×100 mm, 15 mm×90 mm, 20 mm×80 mm, 25 mm×50 mm, 25 mm×75 mm, 30 mm×50 mm, or are shaped substantially ovoid or round having a diameter of, or an average diameter of, between about 5 and 100 mm, between about 20 and 80 mm or between about 25 and 75 mm.

The details of one or more embodiments as provided herein are set forth in the description below. Other features, objects, and advantages of the invention will be apparent from the description, and from the claims.

All publications, patents, patent applications cited herein are hereby expressly incorporated by reference for all purposes.

Reference will now be made in detail to various exemplary embodiments of the invention. The following detailed description is provided to give the reader a better understanding of certain details of aspects and embodiments of the invention, and should not be interpreted as a limitation on the scope of the invention.

### DETAILED DESCRIPTION OF THE INVENTION

In alternative embodiments, provided are phase change materials (PCMs) and thermal energy storage (TES) systems, optionally in the form of gels, and methods for making or producing a shape stable PCM, including methods of making shape stable PCM-comprising products of manufacture. In alternative embodiments, the PCM are encapsulated shape stable PCM. Also provided are methods for producing pelletized, encapsulated and/or coated shape stable PCMs, gels and products of manufacture.

In alternative embodiments, provided are shape stabilized PCMs particles with smaller dimensions such as 3.1 mm (w)×1.8 mm (H), or larger dimensions such as 50 mm×25 mm, and methods for making these PCMs. Exemplary techniques allow shape stable PCM gel particles to be produced at relatively high production rates with dimensions that allow their use in many applications and products of manufacture. In alternative embodiments, the smaller dimensioned PCMs allow the use of different commercially available equipment to produce and fill a variety of containments. In alternative embodiments, provided are products of manufacture including PCMs that have the larger dimensions, e.g., having a shape having dimensions of 10 mm×100 mm, 15 mm×90 mm, 20 mm×80 mm, 25 mm×50 mm, 25 mm×75 mm, 30 mm×50 mm, or are shaped substantially ovoid or round having a diameter of, or an average diameter of, between about 5 and 100 mm, between about 20 and 80 mm or between about 25 and 75 mm; and in alternative embodiment, products of manufacture as provided herein have various mixtures of smaller (e.g., pelletized) and larger PCMs as provided herein, as either or both the smaller and the larger sized PCMs can be encapsulated.

In alternative embodiments, the shape stable PCM gel particles comprise a high latent heat phase change material (PCM) with a large thermal storage capacity, such as a PCM comprising a fatty acid derivative.

In alternative embodiments, the shape stable particles' structure comprises a phase change material (PCM) bound, surrounded by, encapsulated by, or absorbed by a polymer, which in alternative embodiment can form a gel, where optionally the polymer allows the PCM or gel particles to remain substantially dimensionally stable even when the phase change material (PCM) is in the melted or liquid state. In alternative embodiments, the PCM particles are coated with a polymer to provide a protective barrier to prevent any free liquid phase change material (PCM) from escaping the shape stable gel particles. In alternative embodiments, the polymer comprises poly lactic acid (PLA), co-poly lactic acid/glycolic acid (PLGA), cellulose, starch, polyethylene, polypropylene, polyvinyl chloride, polyethylene terephthalate, nylon, polyolefin, ethylene-vinyl acetate, ethylene-vinyl alcohol, ethylene-acrylic acid, polystyrene, polyvinyl alcohol, polyethylene terephthalate, polyethylene naphthalate, polycarbonates, cellulose polymers, polyamide, polyacrylonitrile, acrylonitrile/styrene, or any combination thereof; or, the polymer comprises: a polyester, polyethylene, polypropylene, polypropylene polyethylene co-polymer, ammonium polyphosphate, or any combination thereof.

In alternative embodiments, polymers capable of forming a shape stable PCM gel comprise paraffins, fatty acids, and fatty acid derivatives at low polymer concentrations and high PCM loadings. In alternative embodiments, provided are processes capable of converting the shape stable PCM gel into small shape stable PCM gel particles or relatively larger PCM particles. In alternative embodiments, the PCM particles, e.g., the PCM gel particles, are coated to contain any PCM that may leach from shape stable particles.

In alternative embodiments, shape stabilized PCMs are designed manufactured to accommodate heat transfer and comfort factors, e.g., for a wearable product (e.g., any type of clothing or wearable, including e.g., an apron, a hat, a helmet or hard hat, a bandana or scarf, gloves or mitts, face or eye mask, vest, e.g., a bulletproof or protection vest, or a plate or a bomb suit or a blast-resistant suit). In alternative embodiments, wearable products comprise PCM made by a pelletization technique to yield e.g., about 3-4 mm (W)×1-2 mm (H) particles. These particles can be suspended in an aqueous gel to yield a high heat transfer while still able to absorb/release a relative large amount of heat with the particle. This can be applicable to a product that needs to immediately absorb heat (e.g., to comfort the wearer of the product); however, for longevity of comfort, in alternative embodiments, a larger particle (i.e. lower surface area to volume ratio) is necessary and is used (alone or in combination with smaller, e.g., pelletized particles). In alternative embodiments, PCMs with a geometry of about 50 mm×25 mm are used. While not capable of quickly absorbing as the smaller particle, the larger particles are ideal for sustained temperature control, and can also be formed into a shape that would form well to the wearer.

### Hydrogenated Diene Copolymers, or Equivalents

In alternative embodiment, PCMs as provided herein or PCMs as used to make products of manufacture as provided herein comprise a hydrogenated diene copolymer, which can comprise a conjugated diene copolymer, or a compound as described in U.S. Pat. No. 8,618,205.

For example, PCMs as provided herein can comprise a thermal storage medium composition which comprises about 100 parts by mass of a hydrogenated diene copolymer and about 50 to 4000 parts by mass of a linear paraffin compound having about 12 to 50 carbon atoms, the hydrogenated diene copolymer being a conjugated diene copolymer that is obtained by hydrogenating a block copolymer which includes a polymer block (A) that contains structural units (a-1) derived from a first conjugated diene compound and has a vinyl bond content of not more than about 20 mol %, and a polymer block (B) that comprises structural units (b-1) derived from a second conjugated diene compound and has a vinyl bond content of 30 to 95 mol %, the hydrogenation ratio with respect to the double bonds derived from the conjugated diene compounds being not less than 90%.

Polymer block (A) compounds can comprise a conjugated diene compounds such as e.g., a 1,3-butadiene, isoprene, 2,3-dimethyl-1,3-butadiene, 1,3-pentadiene, 2-methyl-1,3-pentadiene, 1,3-hexadiene, 4,5-diethyl-1,3-octadiene and chloroprene; in alternative embodiments, these conjugated diene compounds are used singly, or two or more kinds may be used in combination.

Structural units (a-1) can comprise about 95 to 100% by mass of 1,3-butadiene-derived structural units, or can consist solely of 1,3-butadiene-derived structural units.

Polymer block (B) compounds can comprise a second conjugated diene compound, and polymer block (B) compounds can further comprise structural units (b-2) can comprise structural units derived from an alkenyl aromatic compound in order to add flexibility to the thermal storage medium composition as well as to prevent the crystallization of the polymer block (B). In alternative embodiments, structural units (b-1) are about 95 to 100% by mass of structural units derived from 1,3-butadiene and/or isoprene, or they can consist solely of structural units derived from 1,3-butadiene and/or isoprene.

### Triblock or Diblock Copolymers, or Equivalents

In alternative embodiments, PCMs as provided herein or PCMs as used to make products of manufacture as provided herein can comprise a triblock or a deblock copolymer, or equivalent.

In alternative embodiments, the triblock copolymer comprises a styrene-ethylene-butylene-styrene (SEBS), a styrene-ethylene-propylene-styrene (SEPS), a styrene-ethylene-ethylene-propylene-styrene (SEEPS), or a combination or equivalents thereof. In alternative embodiments, the diblock copolymer comprises a styrene-ethylene-propylene (SEP), a styrene-ethylene-butylene (SEB), a styrene-ethylene-ethylene (SEE), or a combination or equivalents thereof.

In alternative embodiments, the triblock or the diblock copolymer comprises a compound as described in U.S. Pat. No. 9,556,373, or 9,598,622, for example, a SEBS copolymer can be a high molecular weight SEBS copolymer, optionally with a styrene:rubber ratio of about 30:70 to 33:67% by weight.

In alternative embodiments, the tri-block copolymers have styrene on both ends of the chain and a rubber (such as an ethylene propylene (EP) or ethylene butylene (EB)) in the middle of the chain. In alternative embodiments, a di-block copolymer has a structure comprising styrene on only one end of the chain.

### Ethylene-Octene-Multi-Block Copolymer, or Equivalents

In alternative embodiment, PCMs as provided herein or PCMs as used to make products of manufacture as provided herein comprise an (ethylene-octene)-multi-block copolymer, an (ethylene-butylene)-multi-block copolymer, an (ethylene-octene)-crystalline block copolymer or an (ethylene-butylene)-crystalline block copolymer, or equivalents.

In alternative embodiment, the (ethylene-octene)-multi-block copolymers comprise a compound as described in U.S. Pat. No. 9,593,237; for example, PCMs as provided herein or PCMs as used to make products of manufacture as provided herein can comprise an oil-extended olefin block copolymer composition comprising from about 10 wt % to about 30 wt % of an ethylene/octene multi-block copolymer, which can comprise about 5 wt % to about 20 wt % of hard segments and from 80 wt % to 95 wt % of soft segments; alternatively, the soft segments can comprise from about 9 mol % to about 14.9 mol % units derived from octane. In alternative embodiments, the ethylene/octene multi-block copolymer comprise an overall octene content of about 6.0 mol % to about 14.2 mol %, or from about 30 wt % to about 45 wt % of an oil, or from about 5 wt % to about 20 wt % of one or more polyolefin, or from about 10 wt % to about 50 wt % of a filler.

### Fatty Acids or Fatty Acid Derivatives, or Equivalents

In alternative embodiment, PCMs as provided herein or PCMs as used to make products of manufacture as provided herein comprise at least one fatty acid or fatty acid derivative. For example, in alternative embodiments, the at least one fatty acid or fatty acid derivative comprises e.g., a short-chain fatty acid (SCFA), or a fatty acids with an aliphatic tail of fewer than six carbons, or a butyric acid; or a medium-chain fatty acids (MCFA), or a fatty acid with an aliphatic tails of about 6 to 12 carbons; a long-chain fatty acid (LCFA), or a fatty acid with an aliphatic tail of between 13 to 21 carbons, or between about 10 to 24 carbons; or, a very long chain fatty acid (VLCFA), or a fatty acids with an aliphatic tails longer than 22 carbons, or between about 22 and 30 carbons; or any combination thereof,

In alternative embodiments, the at least one fatty acid or fatty acid derivative comprises a fatty acid or fatty acid derivative compound as described in U.S. Pat. No. 6,574,971 B2, or U.S. Pat. App. Pub. No. 2002/0011587 A1.

For example, PCMs as provided herein or PCMs as used to make products of manufacture as provided herein can comprise: naturally occurring triglycerides; hydrates of acids of triglycerides and their mixtures; refined/synthesized triglyceride products produced by a combination of fractionation and transesterification processes; synthesized triglyceride products using hydrogenation or dehydrogenation, and fractionation; synthesized triglyceride products using cis-trans isomerization and fractionation; synthesized fatty acid derivatives that have the desired freezing point temperatures; refined fatty acid hydrates that have the desired freezing point temperatures; and, mixtures or combinations thereof.

In alternative embodiments, the at least one fatty acid or fatty acid derivative comprises a fatty acid comprising a C2 to C40, or C3 to C30, alkyl or alkene chain, or comprises a substituted C2 to C40, or C3 to C30, alkyl or alkene chain, as described e.g., in U.S. Pat. App. Pub no. 20170254601.

### Fatty Alcohols, or Equivalents

In alternative embodiments, PCMs as provided herein or PCMs as used to make products of manufacture as provided herein comprise fatty alcohols or equivalents, e.g., a fatty alcohol having a C4 to C28 aliphatic hydrocarbon tail. In some embodiments, the hydrocarbon tail is saturated or unsaturated, or branched or linear. In alternative embodiments, PCMs as provided herein or PCMs as used to make products of manufacture as provided herein comprise fatty alcohols such as capryl alcohol, pelargonic alcohol, capric alcohol, underyl alcohol, tridecyl alcohol, myristyl alcohol, pentadecyl alcohol, heptadecyl alcohol, nonadecyl alcohol, arachidyl alcohol, heneicosyl alcohol, behenyl alcohol, lignoceryl alcohol, ceryl alcohol, montanyl alcohol, or mixtures thereof; or, as described in U.S. Pat. App. Pub no 20180148621.

### Gels or Hydrogels

In alternative embodiments, PCMs or TESs as provided herein (e.g., shape stable PCM particles) are contained in or are embedded in a gel or a hydrogel, e.g., a gel or a hydrogel comprising water and a water gelling agent such as a super absorbent polymer, and optionally also comprising a humectant and/or a glycol. The PCM-comprising gel can be encapsulated, or not.

In alternative embodiments, an exemplary hydrogel composition comprises:
Water: 20%-99.50%
Gelling Agent: 0.25%-50%
Humectant: 0.25%-80%

In alternative embodiments, the ratio of gel:shape stable PCM particles may vary from: about 1% w.t. gel:99% w.t. shape stable PCM particles; about 20% w.t gel:80% w.t. shape stable PCM particles; about 40% w.t. gel:60% w.t. shape stable PCM particles; about 50% w.t. gel:50% w.t. shape stable PCM particles; about 60% w.t gel:40% w.t. shape stable PCM particles; about 80% w.t gel:20% w.t. shape stable PCM particles; or, about 99% w.t gel:1% w.t, shape stable PCM particles.

In alternative embodiments, an exemplary gel or hydrogel used with a PCM or TES as provided herein (e.g., where the gel or hydrogel is mixed with or contains a PCM or TES as provided herein) comprises: a gel or hydrogel as described e.g., in U.S. patent application publication nos. 20160122115, or 20170292759, 20170231884, 20170215439; or a sol gel, a silicone gel, a polyacrylamide gel, a polyvinyl alcohol gel, a polyacrylate gel, a cross linked polyacrylic acid, an acrylate polymer, agarose, alginate, methylcellulose, hyaluronan, an acrylic or acrylic derivative polymer crosslinked by a polyamine crosslinking agent, a polyacrylate of sodium or potassium, or any combination thereof

### Encapsulation

In alternative embodiments, a PCM or TES as provided herein, whether in pelletized form or not, is encapsulated or coated, and in alternative embodiments the encapsulation comprises use of a encapsulating or coating material comprising: a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof. In alternative embodiments, a PCM or TES as provided herein are encapsulated or coated in or by using silicate or synthetic fibers are described in U.S. patent application publication no. 20110166568. In alternative embodiments, a PCM or TES as provided herein are encapsulated or coated in or by using e.g., a ceramic, a vinylsilane compound such as a trimethoxyvinylsilane or a triethoxyvinyl silane, polyimide, polyvinylidene fluoride (PVDF), polytetrafluoroethylene (PTFE), fluorinated ethylene propylene (FEP), perfluoroalkoxy (PFA), and mixtures thereof.

In alternative embodiments, a PCM or TES as provided herein are encapsulated or coated in or by using methods as described e.g., in U.S. Pat. Nos. 9,502,646, 9,765,251, 9,879,166 or 9,480,960.

### Products or Articles of Manufacture

In alternative embodiments, provided are methods for thermo-regulating, thermal protecting or insulating a product of manufacture, or provided is a product or an article of manufacture, all using at least one PCM or TES as provided herein, which in alternative embodiments are, or include or comprise: an electrical device or system (e.g., an insulation for a wire, diode, conductor or semiconductor, a radio frequency (RF) switch, or a chip), a computer or an electronic device, a solar energy device, an energy storage device (e.g., a battery such as a lithium-ion battery cell), an appliance (e.g., a heater, an air conditioner, an oven, a freezer or a refrigerator); a telephone or portable electronic device (e.g., a cell phone), a medical device (e.g., a bandage, an orthopedic cast or a boot, or an implant), a storage unit, a building or a building material (e.g., insulation, or roofing, floor or wall materials), a container or storage device, a vehicle, a car (including e.g., TES or insulation for the engine or passenger compartment), a boat or an airplane, a weapon or weapons system (e.g., a rifle or handgun), clothing, garments or apparel or any wearable product (e.g., any type of clothing or wearable, including e.g., an apron, a hat, a helmet or hard hat, a bandana or scarf, gloves or mitts, face or eye mask, vest, e.g., a bulletproof or protection vest, or a plate or a bomb suit or a blast-resistant suit), or a pharmaceutical or a drug or a liquid or a food package or a storage device or container, or a food processing device (e.g., as described in U.S. patent application publication no. 20170215439), or a food (wherein the PCM is ingestible), comprising, comprising use of or incorporating therein a shape stable Phase Change Material (PCM) as provided herein, or a thermal energy storage (TES) system as provided herein.

In alternative embodiments, provided are products or articles of manufacture, all using at least one PCM or TES as provided herein, which in alternative embodiments include or comprise or are: a medical device, a storage unit, a building or a building material (e.g., insulation), a container, a vehicle such as a car, including its engine or passenger compartment, a boat or an airplane, a weapon or weapons system, clothing or apparel, or a pharmaceutical or a drug a liquid or a or food package or storage device or container, comprising or incorporating therein a shape stable Phase Change Material (PCM) as provided herein or a thermal energy storage (TES) system as provided herein.

In alternative embodiment, provided are flame retardant materials, which can comprise silica, a silica vehicle, or a plurality of nanoscale silica particles, e.g., as described in U.S. Pat. No. 9,099,762.

In alternative embodiment, provided are computers, chips or semiconductors comprising a PCM or TES as provided herein, e.g., as described in U.S. Pat. No. 9,984,954; or, U.S. patent application publication no. 2018018268.

In alternative embodiments, provided are: an article of manufacture or a product of manufacture, all using at least one PCM or TES as provided herein, which in alternative embodiments are, or include or comprise: a latent heat storage (LHS) unit, a coating, a liquid, a gel, an antifreeze fluid, a fluid, an ink, an oil, a lubricant, a sealant, a paint, a textile, a cloth, a clothing or an apparel, footwear (e.g., shoes, boots), a bedding or bedding system (e.g., mattresses), a cooling blanket or mat, or a cooling vest or bandage (e.g., a medical bandage or restraint), a flame retardant material, comprising or incorporating therein a shape stable Phase Change Material (PCM) as provided herein or a thermal energy storage (TES) system as provided herein.

Alternative embodiments are further described or defined in the following Examples. It should be understood that these examples, while indicating preferred embodiments of the invention, are given by way of illustration only and are not to be construed as limiting in any manner. From the above discussion and these examples, one skilled in the art can ascertain the essential characteristics of this invention, and without departing from the spirit and scope thereof, can make various changes and modifications to embodiments described herein to adapt it to various usages and conditions.

### EXAMPLES

### Example 1: Exemplary Methods for Making Exemplary Shape Stable PCMs

This example described an exemplary method for making exemplary shape stable PCMs as provided herein.

An (ethylene-butylene)-crystalline block copolymer was used to produce a shape stable PCM gels with fatty acid derivative PCMs, such as PureTemp 29™, PureTemp 18®, PureTemp 68™, PureTemp 20™, PureTemp 4™, PureTemp 63™ and PureTemp 8™ (Entropy Solutions, Inc., of Plymouth, Minn.) and a paraffin and a tetradecane and octadecane. The crystalline block copolymer amount varied from 5% (w.t.) to 95% (w.t.) with the optimal crystalline block copolymer range being 10% (w.t.) to 20% (w.t.). The optimal crystalline block copolymer range allowed a shape stable PCM gel panel to be formed without significant PCM leaching.

To produce shape stable PCM gel particles, a prototype lab scale heated priller was constructed to heat the shape stable PCM gel to a temperature greater than 120° C. At those temperatures, the shape stable PCM gel would melt to form a free-flowing viscous liquid. The heated shape stable PCM gel liquid was fed through a valve and dripped into a container containing liquid nitrogen. The valve controlled the shape stable PCM gel liquid flow allowing small droplets to form.

The droplets were then dripped into a container containing liquid nitrogen. The liquid nitrogen would freeze the molten liquid drop producing a frozen shape stable PCM particle like the process described in U.S. Pat. No. 7,464,564 B2.

After producing the shape stable PCM particles, the particles were thermo-cycled to evaluate the PCM leach rate. The PCM leach rate was not significant, but demonstrated the need to contain the free PCM. In alternative embodiments, any process known in the art can be used to produce pelleted or encapsulated shape stable PCM gel particles, including any common pelletization process to produce shape stable PCM gel particles, such as prilling, extruder pelletization techniques (US 20170087799 A1), pastillation techniques, injection molding techniques, cryogenic pelletization techniques, and equivalents.

A lab scale pan coater was constructed to allow the PCM gel particles to be coated with a polymeric coating. The particles were coated with different coatings, such as methyl cellulose, ethyl cellulose, PVDC, and acrylate copolymers. As the polymer coating level increased, the shape stable PCM gel particles latent heat decreased.

After coating the particles, the coated particles were thermo-cycled to evaluate the PCM leach rate. As the polymer encapsulating coating level increased, the shape stable particles amount of free PCM decreased, producing a contained shape stable PCM gel particle. In alternative embodiments, coating levels ranged from between about 50 (μm)) microns to about 1,000 (μm) microns.

A pilot pelletizing scale trial was performed using pastillation equipment to produce shape stable PureTemp PT 29™ pastilles. The pastillation process produced small pastilles with the following dimensions: 3.1 mm (W)×1.8 mm (H). The pastilles were coated with a PVDC polymer using the constructed pan coater. After coating the pastilles, the pastilles were analyzed by DSC, and the pastilles latent heat decreased as the coating level increased. The coated pastilles were thermo-cycled to evaluate the polymer coating barrier. Similar to the trend observed for the frozen shape stable PCM gel particles, as the coating level increased, the amount of free PCM decreased.

Two commercial scale pelletizing trials were performed using pastillation equipment to produce shape stable PureTemp 18™ and PureTemp 29™ pastilles. The pastillation process produced PT 29™ pastilles approximately 3.6 mm (W)×1.2 mm (H), and PT 18 pastilles approximately 3.0 mm (W)×1.5 mm (H).

In alternative embodiments, any shape or size can be produced, and the desired shape or size of a PCM, TES or stable gel particle as provided herein can be determined by the intended application or desired process of manufacture, and then the best technique for applying a polymer coating is used. In alternative embodiments, any method can be used to shape or size a PCM, TES or stable gel particle as provided herein, e.g., by milling (e.g., dry or wet milling, jar milling, or commercial air-jet milling), rubbing, rolling or shearing, e.g., as described in U.S. Patent application publication nos. 20180016482 and 20180169662; or U.S. Pat. Nos. 9,937,477 and 9,999,579. In alternative embodiments, manufactured PCM, TES or stable gel particles are processed through a sieve analysis to separate particles based on their dimensions or size for specific applications.

Techniques which can be used to coat shape stabilized gel particles are, but not limited to, Wurster coating techniques, tablet coating techniques, pan coating techniques, powder layering coating techniques, and equivalents.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure as provided herein, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A shape stable Phase Change Material (PCM) comprising:
(1) (a)
(i) a hydrogenated diene copolymer, or equivalents,
wherein optionally the hydrogenated diene copolymer comprises a conjugated diene copolymer, or a compound as described in U.S. Pat. No. 8,618,205;
(ii) an (ethylene-octene)-multi-block copolymer, an (ethylene-butylene)-multi-block copolymer, an (ethylene-octene)-crystalline block copolymer or an (ethylene-butylene)-crystalline block copolymer, or equivalents,
wherein optionally the (ethylene-octene)-multi-block copolymer comprises a compound as described in U.S. Pat. No. 9,593,237;
(iii) a triblock copolymer comprising a styrene-ethylene-butylene-styrene (SEBS), a styrene-ethylene-propylene-styrene (SEPS), a styrene-ethylene-ethylene-propylene-styrene (SEEPS), or a combination or equivalents thereof,
wherein optionally the triblock copolymer comprises a compound as described in U.S. Pat. No. 9,556,373;
(iv) a diblock copolymer comprising a styrene-ethylene-propylene (SEP), a styrene-ethylene-butylene (SEB), a styrene-ethylene-ethylene (SEE), or a combination or equivalents thereof,
wherein optionally the diblock copolymer comprises a compound as described in U.S. Pat. No. 9,556,373;
(v) an olefin or polyolefin block copolymer, or equivalent; or
(vi) any combination of (i) to (v) or all of (i) to (v);
(b) a PCM comprising at least one fatty acid or fatty acid derivative;
(c) a paraffin, or equivalent;
(d) a polyol, or equivalent,
wherein optionally the polyol comprises: an aliphatic linear dialkyl ether with a melting point below 100° C. as determined by differential scanning calorimetry, or a polyether,
wherein optionally the polyol is an ether, or a linear ether, having a chain length of between about C6 to C10, C12 to C18, or C6 to C36 in length, or any combination thereof, and optionally the linear ether comprises a di-n-hexyl ether, a di-n-octyl ether, a di-n-decyl ether, a di-n-lauryl ether, a di-n-myristyl ether, a di-n-cetyl ether, a di-n-stearyl ether or any combinations or equivalents thereof;
(e) a fatty alcohol or equivalent; and
(f) a eutectic or equivalent or a eutectic mixture; or
(2) the shape stable PCM of (1), further comprising a coat or coating, or an outer layer encapsulating the shape stable PCM, or an outer layer encapsulating the coated shape stable PCM, or a pelletized form of the shape stable PCM,
wherein optionally the pelletization or encapsulating comprises a process comprising prilling, an extruder pelletization technique (optionally as described in US patent application publication no. 2017/0087799 A1), a pastillation technique, a molding process (e.g., including injection molding, extrusion molding or compression molding), a cutting (e.g., a die cutting) process, a cryogenic pelletization technique, a spheronization technique, a granulation technique, a spray congealing technique, or any equivalent;
and optionally the coating or encapsulation of the PCM-comprising particles, or coating of the encapsulated or pelletized particles, comprises coating or encapsulating material comprising a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof,
wherein optionally the thickness of the coating is about 0.1 μm to 1000 μm, or between about 1.0 μm to about 100 μm,
and optionally the coating level is from about 1% percentage by weight (w.t.) to about 99% percentage by weight (w.t.), from between about 20% percentage by weight (w.t.) to about 80% percentage by weight (w.t.), or from between about 30% percentage by weight (w.t.) to about 70% percentage by weight (w.t.),
and optionally the coating comprises a process comprising a Wurster coating technique, a tablet coating technique, a pan coating technique, a powder layering coating technique, a dip coating technique, a spray drying technique, and equivalents,
and optionally the pelletization process produces PCM particles about 1 to 6 mm, 2 to 5 mm, or about 3 to 4 mm, in width; and about 1 to 2 mm, or about 0.5 to 3 mm in height,
and optionally the PCM particles have a shape having dimensions of 10 mm×100 mm, 15 mm×90 mm, 20 mm×80 mm, 25 mm×50 mm, 25 mm×75 mm, 30 mm×50 mm, or are shaped substantially ovoid or round having a diameter of, or an average diameter of, between about 5 and 100 mm, between about 20 and 80 mm or between about 25 and 75 mm.

2. The shape stable Phase Change Material (PCM) of claim 1, consisting essentially of:
(a)
(i) a hydrogenated diene copolymer or equivalents;
(ii) an (ethylene-octene) multi-block copolymer, or equivalents;
(iii) a triblock copolymer selected from the group consisting of styrene-ethylene-butylene-styrene (SEBS), styrene-ethylene-propylene-styrene (SEPS), styrene-ethylene-ethylene-propylene-styrene (SEEPS), and combinations thereof;
(iv) a diblock copolymer selected from the group consisting of styrene-ethylene-propylene (SEP), styrene-ethylene-butylene (SEB), styrene-ethylene-ethylene (SEE), and combinations thereof, and equivalents thereof;
(v) an olefin or polyolefin block copolymer, or equivalent; or
(vi) any combination of (i) to (v) or all of (i) to (v);
(2) a PCM comprising at least one fatty acid or fatty acid derivative;
(3) a paraffin, or equivalent;
(4) a polyol, or equivalent;
(5) a fatty alcohol or equivalent; and
(6) a eutectic or equivalent or a eutectic mixture; or
(b) the ingredients of claim 1.

3. The shape stable Phase Change Material (PCM) of claim 1, wherein the at least one fatty acid or fatty acid derivative comprises:
(a) a short-chain fatty acid (SCFA), or a fatty acids with an aliphatic tail of fewer than six carbons, or a butyric acid; or a medium-chain fatty acids (MCFA), or a fatty acid with an aliphatic tails of about 6 to 12 carbons; a long-chain fatty acid (LCFA), or a fatty acid with an aliphatic tail of between 13 to 21 carbons, or between about 10 to 24 carbons; or, a very long chain fatty acid (VLCFA), or a fatty acids with an aliphatic tails longer than 22 carbons, or between about 22 and 30 carbons; or any combination thereof,
and optionally the fatty acid comprises a C2 to C40, or C3 to C30, alkyl or alkene chain, or comprises a substituted C2 to C40, or C3 to C30, alkyl or alkene chain,
and optionally the fatty acid is a saturated or an unsaturated fatty acid,
and optionally the fatty acid is: a myristoleic acid or 9-tetradecenoic acid; a palmitoleic acid or 9-hexadecenoic acid; a sapienic acid, an oleic acid; an elaidic acid; a vaccenic acid; a linoleic acid; a linoelaidic acid; an arachidonic acid, or any combination thereof; or
(b) a fatty acid or fatty acid derivative compound as described in U.S. Pat. No. 6,574,971 B2, or U.S. Pat. App. Pub. No. 2002/0011587 A1.
(d) any combination of compounds as described in (a) and/or (b).

4. The shape stable Phase Change Material (PCM) of claim 1, wherein the polyol comprises a monomeric polyol, optionally a sugar alcohol, optionally a glycerin, a polyethylene glycol (PEG), a pentaerythritol, an ethylene glycol or a sucrose, or a polymeric polyol, optionally a polyether or a polyester.

5. The shape stable Phase Change Material (PCM) of claim 1, wherein the fatty alcohol comprises a straight chain primary alcohol, a primary alcohol 4 to 26 carbons long, a fatty alcohol derived from a natural fat or an oil, or derived from an animal fat (optionally a tallow) or vegetable fat, an oleyl alcohol, or any combination thereof.

6. The shape stable Phase Change Material (PCM) of claim 1, wherein the eutectic mixture comprises:
(a) any mixture of elements of claim 1, steps (b) to (d),
(b) a fatty acid combined with a fatty acid derivative, a paraffin, a polyol, a linear ether, a fatty alcohol, a fatty acid, or any combination thereof;
a fatty acid derivative combined with a second fatty acid derivative, a paraffin, a polyol, a linear ether, a fatty alcohol, a fatty acid, or any combination thereof;
a paraffin combined with a fatty acid derivative, a paraffin, a polyol, a linear ether, a fatty alcohol, a fatty acid, or any combination thereof;
a polyol combined with a fatty acid derivative, a paraffin, a polyol, a linear ether, a fatty alcohol, a fatty acid, or any combination thereof; or
a fatty alcohol combined with a fatty acid derivative, a paraffin, a polyol, a linear ether, a fatty alcohol, fatty acid, or any combination thereof; or
(c) any combination of eutectic mixtures of (a) and/or (b).

7. The shape stable Phase Change Material (PCM) of claim 1, wherein the amount of:
the hydrogenated diene copolymer or the (ethylene-butylene)-crystalline block copolymer, or equivalents, or the (ethylene-octene)-crystalline block copolymer or equivalents,
the ethylene/octene multi-block copolymer, or equivalents,
the triblock or diblock copolymers, or equivalents, and/or
the olefin or polyolefin block copolymers, or equivalents,
in the shape stable PCM comprises:
from about 5% percentage by weight (w.t.) to about 95% percentage by weight (w.t.), from between about 7.5% percentage by weight (w.t.) to about 50% percentage by weight (w.t.), or from between about 10% percentage by weight (w.t.) to about 20% percentage by weight (w.t.).

8. The shape stable Phase Change Material (PCM) of claim 1, wherein:
(a) the amount of PCM comprising at least one fatty acid or fatty acid derivative in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.);
(b) the amount of linear ether in the PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.);
(c) the amount of paraffin in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.);
(d) the amount of the polyol comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.);
(e) the amount of fatty alcohol in the shape stable PCM comprises from about 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.); or
(f) the amount of eutectic in the shape stable PCM comprises from 5% percentage by weight (w.t.) to about 95% percentage by weight (w.t.), from between about 10% percentage by weight (w.t.) to about 90% percentage by weight (w.t.), or from between about 15% percentage by weight (w.t.) to about 85% percentage by weight (w.t.).

9-13. (canceled)

14. The shape stable Phase Change Material (PCM) of claim 1, wherein the shape stable PCM comprises:
(a) about 15% (w.t.) hydrogenated diene copolymer and about 85% of a fatty acid, a fatty acid derivative, a paraffin, a polyol, a linear ether, a fatty alcohol, or an eutectic;
(b) about 20% (w.t.) ethylene/octene multi-block copolymer and about 80% (w.t.) of a fatty acid, a fatty acid derivative, a paraffin, a polyol, a linear ether, a fatty alcohol, or an eutectic;
(c) about 10% (w.t.) triblock co-copolymer selected from the group consisting of styrene-ethylene-butylene-styrene (SEBS), styrene-ethylene-propylene-styrene (SEPS), styrene-ethylene-ethylene-propylene-styrene (SEEPS), and about 90% (w.t) of a fatty acid, a fatty acid derivative, a paraffin, a polyol, a linear ether, a fatty alcohol, or an eutectic; or
(d) about 10% (w.t.) diblock copolymer selected from the group consisting of styrene-ethylene-propylene (SEP), styrene-ethylene-butylene (SEB), styrene-ethylene-ethylene (SEE), and about 90% (w.t) of a fatty acid, a fatty acid derivative, a paraffin, a polyol, a linear ether, a fatty alcohol, or an eutectic.

15. A shape stable Phase Change Material (PCM) made by a process comprising:
(1) mixing:
(a)
(i) a hydrogenated diene copolymer, or equivalents,
wherein optionally the hydrogenated diene copolymer comprises a conjugated diene copolymer, or a compound as described in U.S. Pat. No. 8,618,205;
(ii) an (ethylene-octene)-multi-block copolymer, an (ethylene-butylene)-multi-block copolymer, an (ethylene-octene)-crystalline block copolymer or an (ethylene-butylene)-crystalline block copolymer, or equivalents,
wherein optionally the (ethylene-octene)-multi-block copolymer comprises a compound as described in U.S. Pat. No. 9,593,237;
(iii) a triblock copolymer comprising a styrene-ethylene-butylene-styrene (SEBS), a styrene-ethylene-propylene-styrene (SEPS), a styrene-ethylene-ethylene-propylene-styrene (SEEPS), or a combination or equivalents thereof,
wherein optionally the triblock copolymer comprises a compound as described in U.S. Pat. No. 9,556,373;
(iv) a diblock copolymer comprising a styrene-ethylene-propylene (SEP), a styrene-ethylene-butylene (SEB), a styrene-ethylene-ethylene (SEE), or a combination or equivalents thereof,
wherein optionally the diblock copolymer comprises a compound as described in U.S. Pat. No. 9,556,373;
(v) an olefin or polyolefin block copolymer, or equivalent; or
(vi) any combination of (i) to (v) or all of (i) to (v);
(b) a PCM comprising at least one fatty acid or fatty acid derivative;
(c) a paraffin, or equivalent;
(d) a polyol, or equivalent,
wherein optionally the polyol comprises: an aliphatic linear dialkyl ether with a melting point below 100° C. as determined by differential scanning calorimetry, or a polyether,
wherein optionally the polyol is an ether, or a linear ether, having a chain length of between about C6 to C10, C12 to C18, or C6 to C36 in length, or any combination thereof, and optionally the linear ether comprises a di-n-hexyl ether, a di-n-octyl ether, a di-n-decyl ether, a di-n-lauryl ether, a di-n-myristyl ether, a di-n-cetyl ether, a di-n-stearyl ether or any combinations or equivalents thereof;
(e) a fatty alcohol or equivalent; and
(f) a eutectic or equivalent or a eutectic mixture; and
(2) (a) pelletizing: the mixture of (1), or
(b) coating or encapsulating the pelletized PCM-comprising particles of (2)(a),
wherein optionally the pelletizing comprises a process comprising prilling, an extruder pelletization technique (optionally as described in US patent application publication no. 2017/0087799 A1), a pastillation technique, an injection molding technique, a cryogenic pelletization technique, a spheronization technique, a granulation technique, a spray congealing technique, or an equivalent.

16. The shape stable Phase Change Material (PCM) of claim 15, wherein the coating of the PCM-comprising particles, or coating of the encapsulated or pelletized particles, comprises use of a coating comprising a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof,
wherein optionally the thickness of the coating is about 0.1 to 100 μm,
and optionally the coating level is from about 1% percentage by weight (w.t.) to about 99% percentage by weight (w.t.), from between about 20% percentage by weight (w.t.) to about 80% percentage by weight (w.t.), or from between about 30% percentage by weight (w.t.) to about 70% percentage by weight (w.t.),
and optionally the coating comprises a process comprising a Wurster coating technique, a tablet coating technique, a pan coating technique, a powder layering coating technique, a dip coating technique, a spray drying technique, and equivalents.

17. A product of manufacture comprising a shape stable Phase Change Material (PCM) of claim 1,
wherein optionally the product of manufacture comprises pelletized PCM, non-pelletized PCM or a combination of pelletized and non-pelletized PCM,
wherein optionally the about half of the PCM in the product of manufacture is pelletized and about half of the PCM is non-pelletized, or between about 10% to about 90% of the PCM in the product of manufacture is pelletized and between about 10% to about 90% of the PCM is non-pelletized,
and optionally the size of the pelletized PCM is between about 1 to 6 mm, 2 to 5 mm, or about 3 to 4 mm, in width; and between about 1 to 2 mm, or about 0.5 to 3 mm in height,
and optionally the non-pelletized PCM particles have a shape having dimensions of 10 mm×100 mm, 15 mm×90 mm, 20 mm×80 mm, 25 mm×50 mm, 25 mm×75 mm, 30 mm×50 mm, or are shaped substantially ovoid or round having a diameter of, or an average diameter of, between about 5 and 100 mm, between about 20 and 80 mm or between about 25 and 75 mm.

18. The shape stable Phase Change Material (PCM), or product of manufacture, of claim 1, further comprising:
(a) an organic or an inorganic nucleating agent,
wherein optionally the organic nucleating agent comprises a polyolefin or polyalkene, wherein optionally the polyolefin comprises a poly-alpha-olefin,
and optionally the inorganic or organic nucleating agent is in a quantity of between about 0.01% to 1% by mass, or between about 0.1% to 0.5% by mass, or between about 0.01% to 0.1% by mass, or between about 0.5% to 1% by mass; and/or
(b) a filler comprised of an adsorbent material or a thermal conductivity improver,
wherein optionally the filler material is selected from the group consisting of: plastic, activated carbon, graphite, expanded graphite, fullers earth, perlite, diatomaceous earth, cellulose, fibers, silica, celite, wood pulp, corn stover, biomass, bentonite, vermiculite, gypsum, silicon dioxide, attapulgite, graphene oxide, aluminum oxide, cement, molecular sieves, zeolites, metal foams, kaolinite, chlorite, montomorillonite, muscovite, illite, cookeite, GRIT-O-COBB™, silicates, fumed silica, cenospheres, expanded clay aggregates, mica clays, smectite clays, polyacrylate and a combination thereof,
and optionally wherein the plastic is selected from the group consisting of: high-density polyethylene (HDPE) or polyethylene high-density (PEND), Low-density polyethylene (LDPE), Poly(methyl methacrylate) (PMMA) or acrylic glass or acrylic (e.g., PLEXIGLAS™, ACRYLITE™, LUCITE™, PERSPEX™), polystyrene, Ethylene-vinyl acetate (EVA) or poly(ethylene-vinyl acetate) (PEVA), poly(ethylene terephthalate) (PET), thermoplastic elastomers (TPEs) such as styrenic block copolymers (TPE-s), ethylene/butylene block copolymers, crystalline ethylene/butylene block copolymers, thermoplastic olefins (TPE-o), elastomeric alloys (TPE-v or TPV), thermoplastic polyurethanes (TPU), thermoplastic copolyester, thermoplastic polyamides, acrylonitrile butadiene styrene (ABS), polypropylene (PP) or polypropene, equivalents thereof and combinations thereof.

19. A thermal energy storage (TES) system comprising a composition or product of manufacture of claim 1.

20. A method for thermo-regulating, thermal protecting or insulating a product of manufacture, an electrical device or system (e.g., an insulation for a wire, diode, a radio frequency (RF) switch, conductor or semiconductor, or a chip), a computer or an electronic device, a solar energy device, an energy storage device (e.g., a battery), an appliance (e.g., a heater, an air conditioner, an oven, a freezer or a refrigerator); a telephone or portable electronic device, a medical device, a storage unit, a building or a building material (optionally, insulation), a container, a vehicle or its passenger compartment, a car, an engine, a boat or an airplane, a weapon or weapons system, clothing, garments or apparel, or a pharmaceutical or a drug a liquid or a or food package or storage device or container, or a food processing device, or a food (wherein the PCM is ingestible), comprising, comprising use of or incorporating therein a shape stable Phase Change Material (PCM), a product of manufacture or a thermal energy storage (TES) system, of claim 1.

21. A product of manufacture, an electronic device, a solar energy device, an energy storage device (e.g., a battery), a medical device, a storage unit, a building or a building material (optionally, insulation) a container, a vehicle, a boat or an airplane, a weapon or weapons system, or a pharmaceutical or a drug or food package or storage device or container, or a food processing device, or a food (wherein the PCM is ingestible), comprising or incorporating therein a shape stable Phase Change Material (PCM), a product of manufacture or a thermal energy storage (TES) system, of claim 1.

22. An article of manufacture, a product of manufacture, a latent heat storage (LHS) unit, a coating, a liquid, a gel, an antifreeze fluid, a fluid, an ink, an oil, a lubricant, a sealant, a paint, a textile, a cloth, a clothing or an apparel, footwear, a bedding or bedding system, a cooling blanket or mat, a cooling vest or bandage, a flame retardant material, comprising or incorporating therein a shape stable Phase Change Material (PCM), a product of manufacture or a thermal energy storage (TES) system, of claim 1.

23. A method for making a shape stable Phase Change Material (PCM) comprising:
(1) mixing:
(a)
(i) a hydrogenated diene copolymer, or equivalents,
wherein optionally the hydrogenated diene copolymer comprises a conjugated diene copolymer, or a compound as described in U.S. Pat. No. 8,618,205;
(ii) an (ethylene-octene)-multi-block copolymer, an (ethylene-butylene)-multi-block copolymer, an (ethylene-octene)-crystalline block copolymer or an (ethylene-butylene)-crystalline block copolymer, or equivalents,
wherein optionally the (ethylene-octene)-multi-block copolymer comprises a compound as described in U.S. Pat. No. 9,593,237;
(iii) a triblock copolymer comprising a styrene-ethylene-butylene-styrene (SEBS), a styrene-ethylene-propylene-styrene (SEPS), a styrene-ethylene-ethylene-propylene-styrene (SEEPS), or a combination or equivalents thereof,
wherein optionally the triblock copolymer comprises a compound as described in U.S. Pat. No. 9,556,373, or 9,598,622;
(iv) a diblock copolymer comprising a styrene-ethylene-propylene (SEP), a styrene-ethylene-butylene (SEB), a styrene-ethylene-ethylene (SEE), or a combination or equivalents thereof,
wherein optionally the diblock copolymer comprises a compound as described in U.S. Pat. No. 9,556,373, or 9,598,622;
(v) an olefin or polyolefin block copolymer, or equivalent; or
(vi) any combination of (i) to (v) or all of (i) to (v);
(b) a PCM comprising at least one fatty acid or fatty acid derivative;
(c) a paraffin, or equivalent;
(d) a polyol, or equivalent,
wherein optionally the polyol comprises: an aliphatic linear dialkyl ether with a melting point below 100° C. as determined by differential scanning calorimetry, or a polyether,
wherein optionally the polyol is an ether, or a linear ether, having a chain length of between about C6 to C10, C12 to C18, or C6 to C36 in length, or any combination thereof, and optionally the linear ether comprises a di-n-hexyl ether, a di-n-octyl ether, a di-n-decyl ether, a di-n-lauryl ether, a di-n-myristyl ether, a di-n-cetyl ether, a di-n-stearyl ether or any combinations or equivalents thereof;
(e) a fatty alcohol or equivalent; and
(f) a eutectic or equivalent or a eutectic mixture; and
optionally, (2) (a) coating, encapsulating and/or pelletizing: the mixture of (1), or
(b) coating the encapsulated or pelletized PCM-comprising particles of (2)(a),
wherein optionally the encapsulating or pelletizing comprises a process comprising prilling, an extruder pelletization technique (optionally as described in US patent application publication no. 2017/0087799 A1), a pastillation technique, an injection molding technique, a cryogenic pelletization technique, a spheronization technique, a granulation technique, a spray congealing technique, or an equivalent.

24. The method of claim 23, wherein the coating of the PCM-comprising particles, or coating of the encapsulated or pelletized particles, comprises use of a coating comprising a methyl cellulose, an ethyl cellulose, a latex, an acrylic resin, a polyethylene (PE), a polyvinyl chloride (PVC), a styrene maleic anhydride (SMA), a styrene-acrylonitrile (SAN), a polyvinylidene chloride (PVDC) polymer, an acrylate copolymer, a PVDC/PVC polymer, a PVDC/PVC/PE polymer, a polyamide, a polyurethane, a polyvinyl alcohol, a cellulose derivative, or an equivalent thereof,
wherein optionally the thickness of the coating is about 0.1 to 100 μm,
and optionally the coating level is from about 1% percentage by weight (w.t.) to about 99% percentage by weight (w.t.), from between about 20% percentage by weight (w.t.) to about 80% percentage by weight (w.t.), or from between about 30% percentage by weight (w.t.) to about 70% percentage by weight (w.t.),
and optionally the coating comprises a process comprising a Wurster coating technique, a tablet coating technique, a pan coating technique, a powder layering coating technique, a dip coating technique, a spray drying technique, and equivalents.
